(19) United States
(12) Patent Application Publication
(10) Pub. No.: US 2007/0014108 A1
(43) Pub. Date: Jan. 18, 2007

(54) Multi-function tools

(76) Inventor: Alan K. Uke, Poway, CA (US)

Correspondence Address: Daniel M. Chambers;Bio Technology Law Group, 658 Marsolan Avenue, Solana Beach, CA, 92075-1931, US

(21) Appl. No.: 11/326,132

(22) Filed: Jan. 4, 2006

Related U.S. Application Data
(60) Provisional application No. 60/641,201, filed on Jan. 4, 2005.

(51) Int. Cl. F21L 4/00; H04M 1/22

(52) U.S. Cl. 362/191

(57) ABSTRACT

Described are intermediate articles for connecting poles and tools for use in various difficult and/or emergency situations. The intermediate articles comprise a body that includes a first connector for matingly engaging a first mating element disposed on a distal end of a pole at a first angle relative to a longitudinal axis of the pole; opposite the first connector, a second connector for matingly engaging a second mating element disposed on a proximal end of a tool at a second angle relative to a longitudinal axis of the pole; and disposed between the first and second connectors, a receptacle for detachably engaging a removable light source capable of illuminating a tool attached to the pole through the intermediate article. Also described are illuminated tools for use in various difficult and/or emergency situations that comprise a tool portion, which comprises a tool element; an integrated light source, or, alternatively, a receptacle for detachably engaging a removable light source, capable of illuminating the tool portion of the tool; and a connector for matingly engaging a connector disposed on an intermediate article, or for directly matingly engaging an engaging element disposed on a distal end of a pole at an angle relative to a longitudinal axis of the tool portion.

### RELATED APPLICATION

This application claims the benefit of, and priority to, U.S. provisional patent application serial number 60/641,201, filed 4 Jan. 2005, which provisional patent application is hereby incorporated by reference in its entirety for all purposes.

### TECHNICAL FIELD

The field of the present invention relates to tools for use in difficult and/or emergency situations.

### BACKGROUND OF THE INVENTION

1. Introduction

The following description includes information that may be useful in understanding the present invention. It is not an admission that any such information is prior art, or relevant, to the presently claimed inventions, or that any publication specifically or implicitly referenced is prior art.

2. Background

Power distribution and/or electrical transmission systems include various electrical distribution equipment used to maintain and control electrical current transmission through electric lines from generation stations to customers. The electrical distribution equipment includes interrupt assemblies that can interrupt the transmission of electricity through electric lines. Such interrupt assemblies include, for example, fuses, reclosers, and cutout assemblies which function to isolate portions of the transmission lines in the event of electrical surges.

Various fuse structures may be employed for opening a circuit in response to abnormal and/or particularly dangerous power conditions. For example, fuse cutout structures are widely used in the service lines of power distribution systems to open and stop current flow in response to abnormal power line conditions caused by, for example, falling tree branches during a wind storm, lightening striking the lines or equipment, animals crossing the lines, and various other abnormal conditions. Typically, a cutout assembly mounts in line with the electrical lines, transformers, capacitors, regulators, and the like. The fuse cutout structures are generally replaceably mounted within a pole mounted fuse holder and constructed to release and drop from the fuse support or holder, thus allowing a lineman to readily locate the blown fuse. Generally, the lower fuse contact is pivotally mounted in the lower connector of the fuse holder while the upper fuse contact includes a releasable latch mechanism to firmly support the fuse cartridge in place. The latch mechanism usually includes a release lever at the upper end for opening and closing the latch mechanism and thereby providing for removal and insertion of the fuse. When the cutout assembly is open, electrical current does not flow through the assembly to the line or apparatus downstream of the assembly.

Reclosers are interrupting assemblies typically mounted near the tops of utility poles. Under high current surges, the opening and closing of the recloser prevents the surge from communicating further through the transmission and distribution system, thereby electrically protecting the transmission and distribution system from damage. Reclosers are provided with manual operating handles for manually opening and closing the recloser or setting the recloser to lockout after one operation.

Conventionally, such interrupting assemblies include a ring-like conducting part and a hook-like conducting part that are relatively movable between a contacting position for establishing a closed circuit through the device, and a separated position for establishing an open circuit through the device. The interrupting assemblies are designed such that structural features (the rings and/or the hooks) serve as operational catches for various handling tools, for example, hook-sticks or extend-o-sticks. These handling tools are carried on an insulating pole, manipulated by an operator via the pole, and typically comprise a rod-like terminal portion distal from the pole connection portion. The rod-like terminal portion can engage the ring-like portion of the conducting part of the interrupting assembly and/or a second terminal that can loop about the hook-like conducting part of the assembly. The handling tool may be operated by a lineman standing on the ground near the pole, who has climbed the pole, or who is situated on the platform of a bucket truck or the like.

Conventional handling tools are difficult and cumbersome to operate and require skill and patience. It is an object of the present invention to provide improved multi-function tools to be used by electrical and/or power company maintenance groups to make emergency repairs to elevated electrical transmission and power distribution systems, as well as other tools designed for mounting at the end of a shaft or pole opposite the shaft or pole end grasped by a user when using the tool. The tools and tool assemblies of the present invention are particularly valuable in the context of electricity transmission equipment and distribution systems, given that such repairs are often performed under adverse and difficult conditions such as high winds, rain, lightning, and darkness. Moreover, time is of the essence in restoration of electricity supplies and, most importantly, failed attempts to successfully make repairs increase the lineman's exposure to weather conditions or electrical hazards.

### SUMMARY OF THE INVENTION

The present invention provides for multi-function tools to be used in various difficult and/or emergency situations.

In one aspect, an intermediate article for attaching a tool to a pole is provided. The intermediate article comprises a body comprising: a first connector for matingly engaging a first mating element disposed on a distal end of a pole at a first angle relative to a longitudinal axis of the pole; opposite the first connector, a second connector for matingly engaging a second mating element disposed on a proximal end of a tool at a second angle relative to a longitudinal axis of the pole; and disposed between the first and second connectors, a receptacle for detachably engaging a removable light source configured to illuminate a tool attached to the pole through the intermediate article. The first and second angles may the same or different angles. In preferred embodiments, the light source is a battery-operated flashlight. Particularly preferred are flashlights that use one or more light emitting diodes (LEDs) as the light emitting elements. Thus, a related aspect concerns a lighting system that comprises such an intermediate article and a removable light source. Optionally, the intermediate article or lighting system may be mounted to a tool mounted to the intermediate article via a mating engagement between the second connector of the article and a complementary mating element of the tool. The intermediate article or lighting system, with or without being coupled to a tool, may also be mounted to a shaft or pole mounted to the intermediate article via a mating engagement between the first connector of the article and a complementary mating element of the shaft or pole.

In another aspect, a multi-function tool is provided. The tool comprises: a tool portion, comprising a tool element; at least one integrated light source, or a receptacle for detachably engaging the removable light source(s), at least one of which is capable of illuminating the tool portion of the tool; and a connector for matingly engaging an engaging element disposed on a distal end of a shaft or pole at an angle relative to a longitudinal axis of the tool portion, or for matingly engaging a connector disposed on an intermediate article, for example, an intermediate article according to the present invention. In embodiments wherein the multi-function tool includes a receptacle for detachably engaging a removable light source, a removable light source (e.g., a battery-operated LED-based flashlight) is preferably also included, preferably disposed in the receptacle. As will be appreciated, a multi-function tool according to the invention may thus provide illumination of the tool portion when the light source is powered on. A representative example of a multi-function tool according to the invention is one wherein the tool element comprises an arm configured to engage a ring portion of an interrupting assembly (e.g., a distribution cutout or disconnect) in an elevated power distribution and/or electrical transmission system.

In yet another aspect, an illuminating article is provided. The article comprises a light fixture, wherein the light fixture comprises a light source and an attachment element for detachably attaching the light fixture to a pole, or for detachably attaching the light fixture to an intermediate article of the present invention. Importantly, multiple illuminating articles may be attached to the pole and/or intermediate article. As will be appreciated, such a light fixture can be used, for example, to illuminate a detachable tool disposed at or near the distal end of a shaft or pole, opposite the end grasped or otherwise engaged by a person (or machine) holding the shaft or pole.

In yet another aspect, the invention concerns methods of illuminating tools, other articles (e.g., an interrupting assembly in an elevated power distribution and/or electrical transmission system), or areas including the work space where an article or tool according to the invention is to be used.

The intermediate articles, multi-function tools, and light fixtures of the present invention are preferably designed and manufactured to be code compliant, durable, lightweight, and easy to operate. And, importantly, the multiple illuminating capabilities provide a tremendous advantage in difficult and emergency situations.

Other features and advantages of the invention will be apparent from the following drawings, detailed description, and appended claims.

### BRIEF DESCRIPTION OF THE FIGURES

FIG. 1 shows a top-down view of an intermediate article of the present invention.

FIG. 2 shows a view of an illuminated multi-function tool of the present invention.

FIGS. 3 and 4 each illustrate a view of a representative illuminating article embodiment that employs a removable light source designed to illuminate an integral tool portion.

FIG. 5 shows an assembly comprising a light source attached to a telescoping pole in order to illuminate a tool attached to the pole's distal end.

FIG. 6 depicts an assembly comprising a light source and a tool matingly attached to the distal end of a telescoping pole.

### DETAILED DESCRIPTION

As those in the art will appreciate, the following detailed description describes certain preferred embodiments of the invention in detail, and is thus only representative and does not depict the actual scope of the invention. Before describing the present invention in detail, it is understood that the invention is not limited to the particular aspects and embodiments described, as these may vary. It is also to be understood that the terminology used herein is for the purpose of describing particular embodiments only, and is not intended to limit the scope of the invention defined by the appended claims.

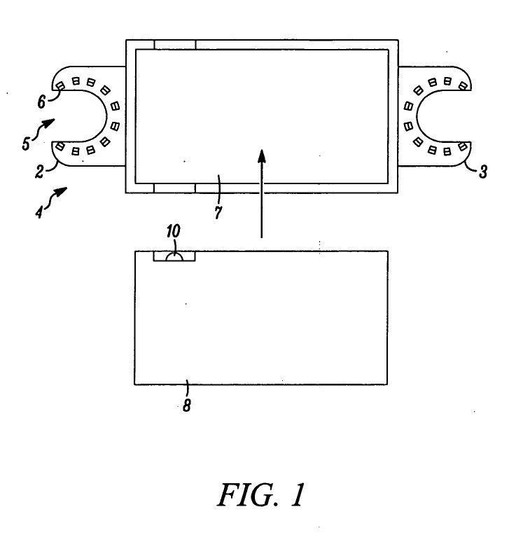

Referring now in more detail to the drawings, FIG. 1 depicts an intermediate article (4) for attaching a tool (not shown) to a pole (not shown), wherein the intermediate article comprises a body comprising: a first connector (2) for matingly engaging a first mating element (not shown) disposed on a distal end of a pole (not shown) at a first angle relative to a longitudinal axis of the pole; opposite the first connector (2), a second connector (3) for matingly engaging a second mating element disposed (not shown) on a proximal end of a tool (not shown) at a second angle relative to a longitudinal axis of the pole; and disposed between the first and second connectors, a receptacle (7) for detachably engaging a removable light source (8) capable of illuminating a tool attached to the pole through the intermediate article. In the depicted embodiment, the first and connectors (2, 3) each comprise a series of splines disposed in an arc about a slot (5) that allows the connector to be positioned about, for example, a bolt, used to bring the connector into mating engagement with a complementary connector disposed on the distal end of a pole, in the case of the first connector (2), or on the proximal end of a tool, in the case of the second connector (3). In this embodiment, the light source (8) includes an LED (10) to provide illumination of a tool attached to the second connector (3). The light source may be removably inserted into the receptacle portion (7), if illumination of the tool is desired. When inserted, the light source is preferably securely retained in the receptacle, for example, using one or more springs, a cover plate, etc.

As with the other aspects and embodiments of the invention, an intermediate article is manufactured from any suitable material, or combination of materials. Preferred materials are those that are durable, lightweight, and easily shaped. Such materials include plastics, fiber-reinforced plastics, and metals, as well as composites of such materials. Particularly preferred materials are aluminum and aluminum alloys, as well as plastics such as high density polyethylene or polypropylene. While less preferred, materials such as ceramic materials may also be employed in construction of the body (or housing or chassis) portion of a device of the invention. To form a housing, any suitable process may be employed, and will depend on factors such as the material used. In the context of plastics, injection molding processes are preferred, whereas with metals and metal alloys, techniques such as casting and/or stamping are preferred, particularly when the device is mass produced. Generally, the articles and tools of the invention are formed as single pieces, although they may also be formed from multiple pieces that are later joined together.

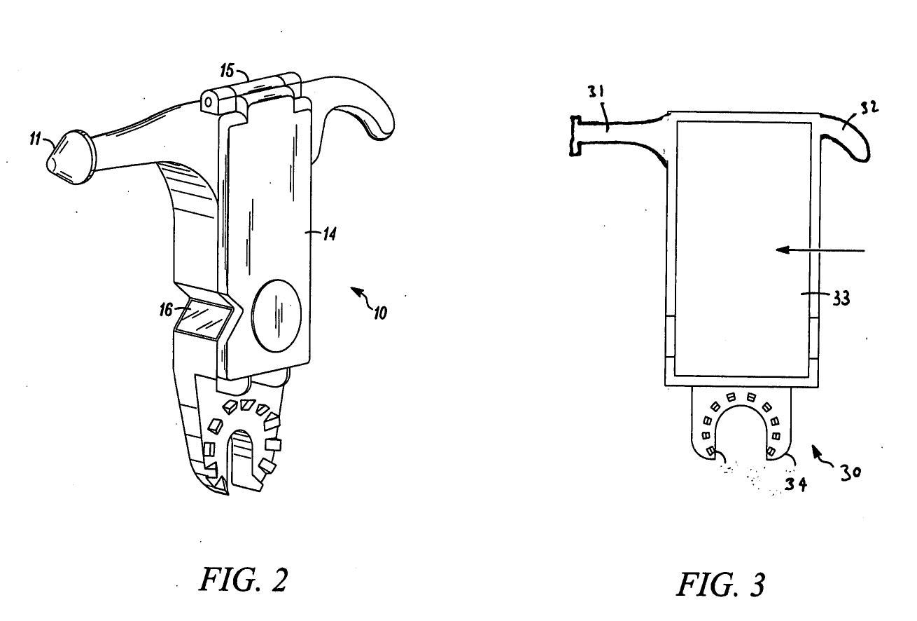

FIG. 2 depicts a particularly preferred embodiment (10) of a multi-functional illuminated tool according to the invention. As shown, the tool portion of the illuminated device is configured to engage a ring portion of an in-line fuse assembly disposed in an elevated electricity distribution system. Other tools which may be integrated into similar devices include other tools for servicing electricity distribution systems, saw, paint rollers, etc. In FIG. 2, the device includes an integrated light source housed within its body. Power for the lamps (not shown) is provided by a battery pack housed under the door (14) connected to the body via a hinge (15). The lamps are housed under a shield (16) that provides protection from heat and arcing. The portion of the tool used for engaging the ring portion of an in-line fuse assembly comprises a pointed tip (11) at the end of an arm. Opposite the arm with a pointed tip is a second tool portion that includes a hook.

The lamp in this embodiment is angled within the housing to provide illumination of this tip, when desired. The light source is activated by depressing a sealed button built into the hinged door, such that depression of the button actuates an on/off switch positioned within the housing such that it can be actuated by depressing the button. In a particularly preferred embodiment, the switch is a multi-position switch, such that one actuation toggles the switch from the “off” to an “on” position where a low light level is delivered from the light source, whereas a second actuation results in the delivery of more light.

Thus, in this and certain other preferred illuminated multi-functional tool embodiments, the tool includes at least one integrated light source, or a housing that includes a receptacle for one or more removable or detachable light sources. In any case, a light source comprises one or more lamps in electrical communication with a power supply. Preferably, a lamp is light bulb or an LED. Preferred power supplies include one or more batteries, which may or may not be rechargeable. Electrical communication between the lamp(s) and power supply is provided by any suitable circuitry, and will depend on the particular device and its intended application. Preferably, such circuitry includes at least an on/off switch to open and close the circuit between the lamp(s) and power supply, and wiring or other circuitry to complete the electrical circuit(s) in the device.

As those in the art will appreciate, a light source may be integrated, or built into the tool. Such a configuration does not preclude the possibility that certain components, for example, wear items such as a light bulb, cannot be replaced, as they may be. Similarly, the power supply, for example, one or more batteries, may be removable, such that they may be recharged or replaced. Of course, if the power supply is rechargeable and employs batteries that may not be removed (or at least easily removed), the device will further comprise a recharging circuit for recharging the one or more batteries following use of the tool. For battery-powered power supplies, any suitable battery may be employed, and will depend on factors such as the power requirements of the particular light source, the amount of power required, the size and configuration of the battery compartment, etc.

In other embodiments, the tool comprises a housing that serves as a receptacle for a removable light source. In this way, the tool may be used without the light source, for example, in daylight or under other conditions such that the ambient light in the vicinity where the tool will be used is sufficient. Such embodiments may be particularly desired where tool weight is a consideration.

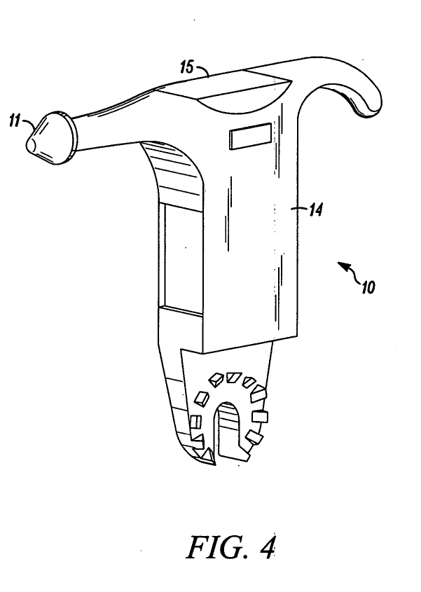

FIG. 3 depicts a multi-function tool (30) similar to that shown in FIG. 2, the difference being that in the embodiment of FIG. 3, the tool comprises: a tool portion, comprising two tool elements (31, 32); a receptacle (33) for detachably engaging a removable light source (not shown) capable of illuminating a tool portion (31) of the tool; and a connector (34) for matingly engaging an engaging element disposed on a distal end of a pole (not shown) at an angle relative to a longitudinal axis of the tool portion, or for matingly engaging a connector disposed on an intermediate article of the present invention. The multi-function tool may thus be illuminated when necessary by inclusion of a light source in the receptacle.

FIG. 4 depicts another embodiment of a multi-function tool that can incorporate a removable light source. In this embodiment, the light source (15) is inserted into the tool through a slot in the top of the tool portion.

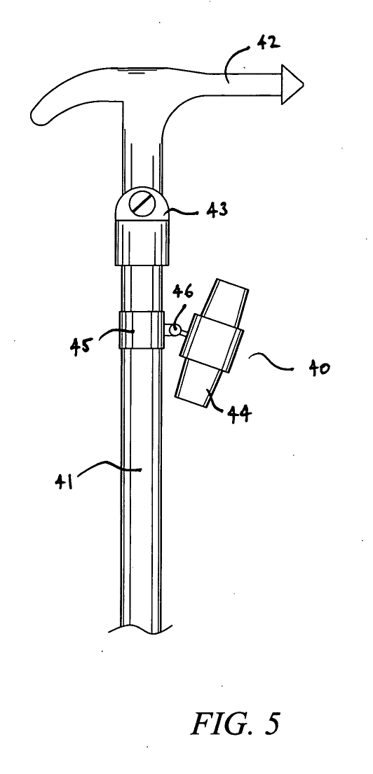

FIG. 5 depicts an assembly comprising a light fixture (40) attached to a telescoping pole (41) in order to illuminate a tool (42) attached to the pole's distal end (43). The light fixture (40) comprises a light source (44), wherein the light and an attachment element (45) for detachably attaching the light fixture to a pole, or for detachably attaching the light fixture to an intermediate article of the present invention. As shown, the attachment element (45) further comprises an articulating element (46) that allows the angle of the light source to be adjusted relative to the longitudinal axis of the pole. Moreover, the attachment element may be used to attach the light fixture at any position along the length of the pole. As shown in FIG. 5, the light source (44) is preferably a flashlight.

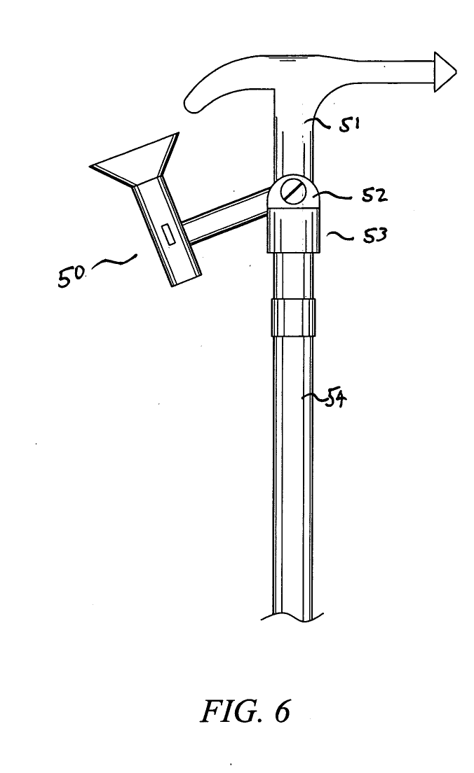

FIG. 6 depicts an assembly similar to that shown in FIG. 5, although in the embodiment in FIG. 6, the assembly comprises a light fixture (50) and a tool (51) attached via a connector (52) at the distal end (53) of a telescoping pole (54) in order to illuminate a portion of the tool (51). The light fixture (50) comprises a light source.

In the practice of the various aspects of this invention, the intermediate articles, multi-function tools and light fixtures are attached to a pole or stick. Here, a “pole” refers to any suitable device that can be gripped at one end (i.e., the “proximate end”, which is the end nearest a user) and to which an intermediate article or multi-function tool according to the invention may be attached at the other end (i.e., the “distal end”). Any suitable pole or stick may be employed. Whether a particular pole is suited for a particular application will depend on various factors known in the art. Preferred poles for use in conjunction with electricity transmission equipment are generally insulated to protect the user (e.g., a lineman) from, for example, electric shock. Frequently, such poles are made from a fine weave uni-directional electrical grade fiberglass laminate applied over a unicellular foam core. The pole is then finished with a hard-gloss, porosity-free epoxy sealer. While such fiberglass or other composite poles are preferred due to their increased moisture resistance, stiffness, strength, and service life, and improved electrical properties as compared to poles made from less preferred materials such as wood, poles made from other materials may also be employed. Particularly preferred are telescoping poles made from fiberglass or other composite materials.

In many preferred embodiments, a pole used in the practice of the invention includes a “universal” fitting at its distal end for secure attachment of the article or tool of the invention. Such a universal fitting generally comprises a metal casting that, at one end, has a bore into which the distal end of the pole can be inserted and the fitting secured to the pole using any suitable fastening technique or device, including complementary threaded portions in the bore and of the distal end, fasteners (e.g., pins, rivets, screws), etc. The fitting also includes a set of a spaced teeth or splines arrayed about a circular arc, which teeth are adapted to accept and engage the teeth of another such fitting when two such fitting are positioned in proximity to one another in manner that allows the teeth of one fitting to fall into gaps disposed between the teeth of the complementary fitting. Examples of tools having a universal fitting disposed at their pole-connecting portions are shown in several of the figures (e.g., FIGS. 1-4). To allow one universal fitting to be connected to another, one of the fittings, preferably the fitting on the article or tool, also includes a slot so that the article can be disposed about a bolt, screw, or other suitable fastener that extends through the complementary fitting attached to the end of the pole.

As is known, such a universal fitting provides for secure attachment of an article by way of a complementary universal fitting, typically (but not necessarily) disposed at one end of the article or tool. See, e.g., FIG. 2. As those in the art will appreciate, coupling between “universal” connectors on both a tool and distal pole end also allows the user to secure the tool to the pole at any of a number of different pre-determined angles. As will be appreciated, the angles that may be selected are determined by the teeth (size, spacing, etc.) and gaps between the teeth in the universal fittings. Also, in the context of an intermediate article according to the invention, the angle at which one universal fitting is attached to a pole may be different from the angle selected for attachment of a tool to the other end of the intermediate article.

While the articles and tools of the invention preferably include one or more universal fittings for attachment to other articles, tools, and poles, those in the art will understand that an article or tool can be manufactured to include any structure adapted for secure, mated engagement or other attachment to a complementary structure on another article, tool, or pole. Other suitable structures include various mechanical locks, friction between opposed surfaces, etc. Regardless of the particular structure selected, such fittings and structures preferably provide for some degree of flexibility in the angle of attachment between the two items so that, for example, the particular tool can be attached to a pole at the angle determined by the user in the field as optimal in the particular circumstance. That said, the invention also includes embodiments that do not provide for such adjustability.

The instant intermediate articles and tools are designed to be assembled with other components, such as poles and tools. For example, an intermediate article can be assembled between a pole and a tool such the article is interposed between the distal end of the pole and the connecting portion of the tool. Similarly, a multi-function tool with a “universal” connector can be mated to a telescoping pole having a complementary universal connector at its distal end. Such assemblies can then be used for their intended purpose, for example, to illuminate a work area in the vicinity of the tool portion of the assembly.

### EXAMPLE

The following example is provided to illustrate certain aspects of the present invention and to aid those of skill in the art in practicing the invention. These examples are in no way to be considered to limit the scope of the invention in any manner.

### Example 1

### Hot Stick Finger Light

This example describes a particularly preferred embodiment of a multi-functional tool according to the invention, as is depicted in FIG. 2.

This multi-function tool has a built-in, battery-powered LED light for use in dark or unlighted areas, making it safer and more efficient for night operations than conventional, non-illuminated tools. This tool, which measures 5.7×4.8×0.8 inch and weighs less than 7 ounces (including three alkaline AAA or lithium AAA-cell batteries accessed through a hinged (15), easy access battery door (14) that locks via a spring), also includes a splined, slotted universal connector that allows it to be securely attached to any suitable pole having a complementary universal fitting at its distal end. The light source integrated into the light-weight aluminum, Faraday cage chassis (or body) includes a bright, unbreakable high intensity 1-watt white LED lamp and associated electronics. To conserve battery power, this lamp has two intensity settings, high and low, which are selectable through the three-way switch (off, on-low, on-high). On “high”, the lamp has a maximum brightness of 15 lumens (high setting) and has a run time of 4 hours, while on “low” the run time is 10 hours at a brightness of 7 lumens. The body of the tool includes a water-resistant battery compartment with a sealed silicone rubber push button to turn the LED lamp on or off and to adjust lamp intensity. To protect the LED from heat and flash, as may be associated with electrical arcing, the LED is protected by a sealed borosilicate window (16). This configuration has been tested using an arc blast test to withstand 30 one-half second cycles of 3000 volt (V), 8000 ampere (A) arcing electricity.

The tool portion of this device has two components, a notched straight arm to secure a fuse, cutout, or disconnect using a hot stick. As shown in FIG. 2, the distal end of the straight arm includes a pointed head (11) for breaking off of ice or other debris that may be obstructing access to the ring on the fuse designed to accept the tool end. Opposite the straight arm is a curved arm, which can be used to hang the tool/pole assembly. This and similar tools can be used by linemen in servicing fuse barrels, cut outs, switches, disconnects in the field.

All of the articles and methods disclosed and claimed herein can be made and executed without undue experimentation in light of the present disclosure. While the articles and methods of this invention have been described in terms of preferred embodiments, it will be apparent to those of skill in the art that variations may be applied to the articles and methods without departing from the spirit and scope of the invention. All such variations and equivalents apparent to those skilled in the art, whether now existing or later developed, are deemed to be within the spirit and scope of the invention as defined by the appended claims.

As those in the art will appreciate, the appended claims are directed to patentable articles of manufacture, assemblies, systems, and methods. Here, “patentable” means that the claimed subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

All patents, patent applications, and publications mentioned in the specification are indicative of the levels of those of ordinary skill in the art to which the invention pertains. All patents, patent applications, and publications are herein incorporated by reference in their entirety for all purposes and to the same extent as if each individual publication was specifically and individually indicated to be incorporated by reference in its entirety for any and all purposes.

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. An intermediate article for attaching a tool to a pole, wherein the intermediate article comprises a body, the body comprising:
a. a first connector for matingly engaging a first mating element disposed on a distal end of a pole at a first angle relative to a longitudinal axis of the pole;
b. opposite the first connector, a second connector for matingly engaging a second mating element disposed on a proximal end of a tool at a second angle relative to a longitudinal axis of the pole; and
c. disposed between the first and second connectors, a receptacle for detachably engaging a removable light source capable of illuminating a tool attached to the pole through the intermediate article.

2. An intermediate article according to claim 1 further comprising a removable light source detachably engaged in the receptacle.

3. An intermediate article according to claim 2, wherein the removable light source is a flashlight.

4. An intermediate article according to claim 3, wherein the flashlight is a battery powered LED flashlight.

5. An assembly, comprising an intermediate article according to claim 1 connected to a tool.

6. An assembly according to claim 5, wherein the intermediate article further comprises a removable light source detachably engaged in the receptacle.

7. An assembly according to claim 5, wherein the tool is configured to engage a ring portion of an interrupting assembly disposed in an elevated electricity distribution system.

8. An assembly, comprising an intermediate article according to claim 1 connected to a pole.

9. An assembly according to claim 8, wherein the intermediate article further comprises a removable light source detachably engaged in the receptacle.

10. An assembly according to claim 8, wherein the intermediate article is further connected to a tool.

11. An assembly according to claim 10, wherein the intermediate article further comprises a removable light source detachably engaged in the receptacle.

12. An assembly according to claim 10, wherein the tool is configured to engage a ring portion of an interrupting assembly disposed in an elevated electricity distribution system.

13. An assembly according to claim 8, wherein the pole is electrically insulated.

14. An intermediate article according to claim 1, wherein first connector is capable of engaging the first mating element disposed on a distal end of a pole at a first angle selected by a user.

15. An intermediate article according to claim I, wherein second connector is capable of engaging the second mating element disposed on a proximal end of a tool at a first angle selected by a user.

16. A tool, comprising:
a. a tool portion, comprising a tool element;
b. a receptacle for detachably engaging a removable light source capable of illuminating the tool portion of the tool; and
c. a connector for matingly engaging an engaging element disposed on a distal end of a pole at an angle relative to a longitudinal axis of the tool portion.

17. A tool according to claim 16 further comprising a removable light source detachably engaged in the receptacle.

18. A tool according to claim 17, wherein the removable light source is a flashlight.

19. A tool according to claim 18, wherein the flashlight is a battery powered LED flashlight.

20. A tool according to claim 16, wherein the tool element is selected from the group consisting of an arm configured to engage a ring portion of an in-line fuse assembly disposed in an elevated electricity distribution system, a saw, and a paint roller.

21. An assembly comprising a tool according to claim 16 connected to a pole.

22. An assembly according to claim 21, wherein the tool further comprises a removable light source detachably engaged in the receptacle.

23. An assembly according to claim 22, wherein the wherein the removable light source is a flashlight.

24. An assembly according to claim 23, wherein the flashlight is a battery powered LED flashlight.

25. A tool, comprising:
a. a tool portion, comprising a tool element;
b. a light source capable of illuminating the tool portion of the tool; and
c. a connector for matingly engaging an engaging element disposed on a distal end of a pole at an angle relative to a longitudinal axis of the tool portion.

26. A tool according to claim 25, wherein the removable light source is a flashlight.

27. A tool according to claim 26, wherein the flashlight is a battery powered LED flashlight.

28. A tool according to claim 25, wherein the tool element is selected from the group consisting of an arm configured to engage a ring portion of an in-line fuse assembly disposed in an elevated electricity distribution system, a saw, and a paint roller.

29. An assembly comprising a tool according to claim 25 connected to a pole.

30. A method of illuminating a detachable tool disposed at the distal end of a pole, comprising attaching to the pole a battery-powered light fixture positioned to illuminate the tool.

31. A method according to claim 30, wherein the battery-powered light fixture comprises a light source, a battery receptacle in electrical communication with the light source, one or more batteries disposed in the battery receptacle, and a pole attachment element for detachably attaching the light fixture to the pole.

32. A method according to claim 31, wherein the battery-powered light fixture is connected to the pole attachment element through an articulating member that allows the position of the light source to be adjusted relative to the pole attachment element.

33. A method according to claim 30, wherein the light source is detachable from the light fixture.

34. An article comprising a battery-powered light fixture, wherein the light fixture comprises a light source, a battery receptacle in electrical communication with the light source, and a pole attachment element for detachably attaching the light fixture to a pole.

35. An article according to claim 34, wherein the removable light source is a flashlight.

36. An article according to claim 34, wherein the flashlight is an LED flashlight.
